(19) United States
(12) Patent Application Publication
(10) Pub. No.: US 2009/0051790 A1
(43) Pub. Date: Feb. 26, 2009

(54) De-parallax methods and apparatuses for lateral sensor arrays

(75) Inventor: Scott P. Campbell, Thousand Oaks, CA (US)

Correspondence Address: DICKSTEIN SHAPIRO LLP, 1825 EYE STREET, NW, WASHINGTON, DC, 20006, US

(73) Assignee: Micron Technology, Inc.

(21) Appl. No.: 11/892,230

(22) Filed: Aug. 21, 2007

(51) Int. Cl. H04N 5/217

(52) U.S. Cl. 348/241; 348/E05.078

(57) ABSTRACT

An object perceived by a lateral sensor array effected by parallax is shifted to correct for parallax error. A void resulting from said shift is filled by examining and interpolating image and color content from other locations.

### BACKGROUND OF THE INVENTION

1. Field of the Invention

Embodiments of the invention relate generally to digital image processing and more particularly to methods and apparatuses for image pixel signal readout.

2. Background of the Invention

There is a current interest in using CMOS active pixel sensor (APS) imagers as low cost imaging devices. An example pixel 10 of a CMOS imager 5 is described below with reference to FIG. 1. Specifically, FIG. 1 illustrates an example 4T pixel 10 used in a CMOS imager 5, where “4T” designates the use of four transistors to operate the pixel 10 as is commonly understood in the art. The 4T pixel 10 has a photosensor such as a photodiode 12, a transfer transistor 11, a reset transistor 13, a source follower transistor 14, and a row select transistor 15. It should be understood that FIG. 1 shows the circuitry for the operation of a single pixel 10, and that in practical use there will be an M×N array of identical pixels arranged in rows and columns with the pixels of the array being accessed by row and column select circuitry, as described in more detail below.

The photodiode 12 converts incident photons to electrons that are transferred to a storage node FD through the transfer transistor 11. The source follower transistor 14 has its gate connected to the storage node FD and amplifies the signal appearing at the node FD. When a particular row containing the pixel 10 is selected by the row select transistor 15, the signal amplified by the source follower transistor 14 is passed to a column line 17 and to readout circuitry (not shown). It should be understood that the imager 5 might include a photogate or other photoconversion device, in lieu of the illustrated photodiode 12, for producing photo-generated charge.

A reset voltage Vaa is selectively coupled through the reset transistor 13 to the storage node FD when the reset transistor 13 is activated. The gate of the transfer transistor 11 is coupled to a transfer control line, which serves to control the transfer operation by which the photodiode 12 is connected to the storage node FD. The gate of the reset transistor 13 is coupled to a reset control line, which serves to control the reset operation in which Vaa is connected to the storage node FD. The gate of the row select transistor 15 is coupled to a row select control line. The row select control line is typically coupled to all of the pixels of the same row of the array. A supply voltage Vdd, is coupled to the source follower transistor 14 and may have the same potential as the reset voltage Vaa. Although not shown in FIG. 1, column line 17 is coupled to all of the pixels of the same column of the array and typically has a current sink transistor at one end.

As known in the art, a value is read from the pixel 5 using a two-step process. During a reset period, the storage node FD is reset by turning on the reset transistor 13, which applies the reset voltage Vaa to the node FD. The reset voltage actually stored at the FD node is then applied to the column line 17 by the source follower transistor 14 (through the activated row select transistor 15). During a charge integration period, the photodiode 12 converts photons to electrons. The transfer transistor 11 is activated after the integration period, allowing the electrons from the photodiode 12 to transfer to and collect at the storage node FD. The charges at the storage node FD are amplified by the source follower transistor 14 and selectively passed to the column line 17 via the row select transistor 15. As a result, two different voltages—a reset voltage (Vrst) and the image signal voltage (Vsig)—are readout from the pixel 10 and sent over the column line 17 to readout circuitry, where each voltage is sampled and held for further processing as known in the art.

FIG. 2 shows a CMOS imager integrated circuit chip 2 that includes an array 20 of pixels and a controller 23 that provides timing and control signals to enable the reading out of the above described voltage signals stored in the pixels in a manner commonly known to those skilled in the art. Typical arrays have dimensions of M×N pixels, with the size of the array 20 depending on a particular application. Typically, in color pixel arrays, the pixels are laid out in a Bayer pattern, as is commonly known. The imager 2 is read out a row at a time using a column parallel readout architecture. The controller 23 selects a particular row of pixels in the array 20 by controlling the operation of row addressing circuit 21 and row drivers 22. Charge signals stored in the selected row of pixels are provided on the column lines 17 to a readout circuit 25 in the manner described above. The signals (reset voltage Vrst and image signal voltage Vsig) read from each of the columns are sampled and held in the readout circuit 25. Differential pixel signals (Vrst, Vsig) corresponding to the readout reset signal (Vrst) and image signal (Vsig) are provided as respective outputs Vout1, Vout2 of the readout circuit 25 for subtraction by a differential amplifier 26, and subsequent processing by an analog-to-digital converter 27 before being sent to an image processor 28 for further processing.

In another aspect, an imager 30 may include lateral sensor arrays as shown in FIG. 3. This type of imager is also known as an “LSA” or “LiSA” imager, has color planes separated laterally into three distinct imaging arrays. As depicted in the top plan view of FIG. 3, the imager 30 has three M×N arrays 50B, 50G, 50R, one for each of the three primary colors Blue, Green, and Red, instead of the having one Bayer patterned array. The distance between the arrays 50B, 50G, 5OR shown as distance A. An advantage of using an LSA imager is that part of the initial processing for each of the colors is done separately; as such, there is no need to adjust the processing circuits (for gain, etc.) for differences between image signals from different colors. The distance between the arrays shown as distance A.

A disadvantage of using an LSA imager is the need to correct for increased parallax error that often occurs. Parallax is generally understood to be an array displacement divided by the projected (object) pixel size. In a conventional pixel array that uses Bayer patterned pixels, four neighboring pixels are used for imaging the same image content. Thus, two green pixels, a red pixel, and a blue pixel are co-located in one area. With the four pixels being located close together, parallax error is generally insignificant. In LSA imagers, however, the parallax error is more pronounced because each color is spread out among three or more arrays. FIG. 4 depicts a top plan view of a portion of an LSA imager 30 and an object 66. Imager 30 includes three arrays 50B, 50G, 5OR, and lenses 51B, 51G, 51R for each of the arrays, respectively.

Parallax geometry is now briefly explained. In the following equations, δ is the width of one pixel in an array 50R, 50G, 50B, D is the distance between the object 66 and a lens (e.g., lenses 51R, 51G, 51B), and d is the distance between a lens and an associated array. Δ is the projection of one pixel in an array, where object 66 embodies that projection. Δ decreases as D increases. Σ is the physical shift between the centers of the arrays 50R, 50G, 50B. Σ is calculated as follows: Σ=A·N·δ, where A is the gap between the pixel arrays, and N is the number of pixels in the array.

If the green pixel array 50G is in between the blue pixel array 50B and the red pixel array 50R, as depicted in FIG. 4, and used as a reference point, then −Σ is the shift from the green pixel array 50G to the red pixel array 50R. Furthermore, +Σ is the shift from the green pixel array 50G to the blue pixel array 50B. Γ is the angular distance between similar pixels in different color channels to the object 66. Γ changes as D changes. θ, is the field of view (FOV) of the camera system. γ is the angle that a single pixel in an array subtends on an object 66. Imager software can correlate the separation between the pixel arrays in an LSA imager 30. σ is sensor shift that software in an imager applies to correlate corresponding pixels. σ is generally counted in pixels and can be varied depending on the content of the image. P is the number of pixels of parallax shift. P can be computed based on the geometric dimensions of the imager 30 and the object 66, as depicted in FIG. 4. Parallax can be calculated from the spatial dimensions as follows:

$$\begin{matrix}P = \frac{A \cdot N \cdot δ}{Δ} = \frac{Σ}{Δ} & ( 1 ) \\ Δ = \frac{δ \cdot D}{d} & ( 2 ) \\ P = \frac{A \cdot N \cdot δ}{D} \approx \frac{A \cdot N \cdot f}{Δ} & ( 3 ) \\ Δ = \frac{2 \cdot D \cdot tan ( \frac{Θ}{2} )}{N} & ( 4 ) \\ P = \frac{A \cdot δ \cdot {N}^{2}}{2 \cdot D \cdot tan ( \frac{Θ}{2} )} & ( 5 ) \\ P - σ = \frac{Σ \cdot f}{δ \cdot D} & ( 6 )\end{matrix}$$

Parallax can also be calculated from the angular dimensions as follows:

$$\begin{matrix}P = \frac{Γ}{γ} & ( 7 ) \\ Γ \approx \frac{A \cdot N \cdot γ}{D} = \frac{Σ}{D} & ( 8 ) \\ γ \approx \frac{Δ}{D} = \frac{δ}{d} & ( 9 ) \\ P = \frac{A \cdot N \cdot d}{D} \approx \frac{A \cdot N \cdot f}{Δ} & ( 10 ) \\ γ \approx \frac{2 \cdot tan ( \frac{Θ}{2} )}{N} & ( 11 ) \\ P = \frac{A \cdot δ \cdot {N}^{2}}{2 \cdot D \cdot tan ( \frac{Θ}{2} )} & ( 12 )\end{matrix}$$

Thus the number of pixels of parallax shift P is calculated with the same parameters for both spatial and angular dimensions.

Hyperparallax, or Hyperparallax distance, is the distance at which a pixel shift of one occurs. FIG. 5a depicts a top down block representational view of an image scene perceived by an imager with a shift σ of 0. According to equation 6, P equals 0 when D=∞, P equals 1 when D=D_{HP}, P equals 2 when D=D_{HP}/2. Thus, in images received by the imager having arrays 50R, 50G, 50B from an object at a distance D=∞, there is no parallax shift. In images received from an object at a distance D=2*D_{HP}, there is a ½ pixel of parallax shift. In images received from an object at distance D=D_{HP}, there is a 1 pixel parallax shift. In images received from an object at distance D=D_{HP}/2, there are 2 pixels of parallax shift.

FIG. 5b depicts a top down block representational view of an image scene perceived by an imager with a shift σ of 1. According to equation 6, P equals −1 when D=∞, P equals 0 when D=D_{HP}, P equals 1 when D=D_{HP}/2. Thus, in images received by the imager having arrays 50R, 50G, 50B from an object at distance D=∞, there is a −1 pixel parallax shift. In images received from an object at distance D=2*D_{HP}, there is a ½ pixel parallax shift. In images received from an object at distance D=D_{HP}, there is no parallax shift. In images received from an object at distance D=D_{HP}/2, there is a 1 pixel parallax shift.

Imager shift's σ can be applied selectively to image content, where none, some, or all of the image content is adjusted. In an image that has objects at different distances from an imager, different σ's can be applied depending on the perceived distance of the object.

However, when applying a parallax shift to an image, there is a void that occurs in the area behind the shifted pixels. For example, if an image is shifted 2 pixels to the left, there will be portions of 2 columns that will be missing image content because of the shift. Thus, there is a need to correct for the lost image content due to a shift.

### BRIEF DESCRIPTION OF THE DRAWINGS

FIG. 1 is an electrical schematic diagram of a conventional imager pixel.

FIG. 2 is a block diagram of a conventional imager integrated chip.

FIG. 3 is a block diagram of a conventional lateral sensor imager.

FIG. 4 depicts a top down view of a block representation of an image scene perceived by a lateral sensor imager

FIGS. 5a and 5b depict a top down block representation of an image scene perceived by a lateral sensor imager.

FIG. 6 depicts objects perceived by a lateral sensor array.

FIG. 7 depicts objects perceived by a lateral sensor array.

FIG. 8 depicts objects perceived by a lateral sensor array that are shifted, resulting in voids.

FIG. 9 depicts shifted objects perceived by a lateral sensor array, voids and image content correction regions.

FIG. 10 depicts shifted objects perceived by a lateral sensor array and patched voids.

FIG. 11 is a block diagram representation of a system incorporating an imaging device constructed in accordance with an embodiment described herein.

### DETAILED DESCRIPTION OF THE INVENTION

In the following detailed description, reference is made to the accompanying drawings, which are a part of the specification, and in which is shown by way of illustration various embodiments of the invention. These embodiments are described in sufficient detail to enable those skilled in the art to make and use them. It is to be understood that other embodiments may be utilized, and that structural, logical, and electrical changes, as well as changes in the materials used, may be made.

Embodiments disclosed herein provide de-parallax correction, which includes interpreting and replacing image and color content lost when performing a de-parallax shifting of image content. An embodiment of the invention there are four steps of the de-parallax correction process: identification, correlation, shifting, and patching.

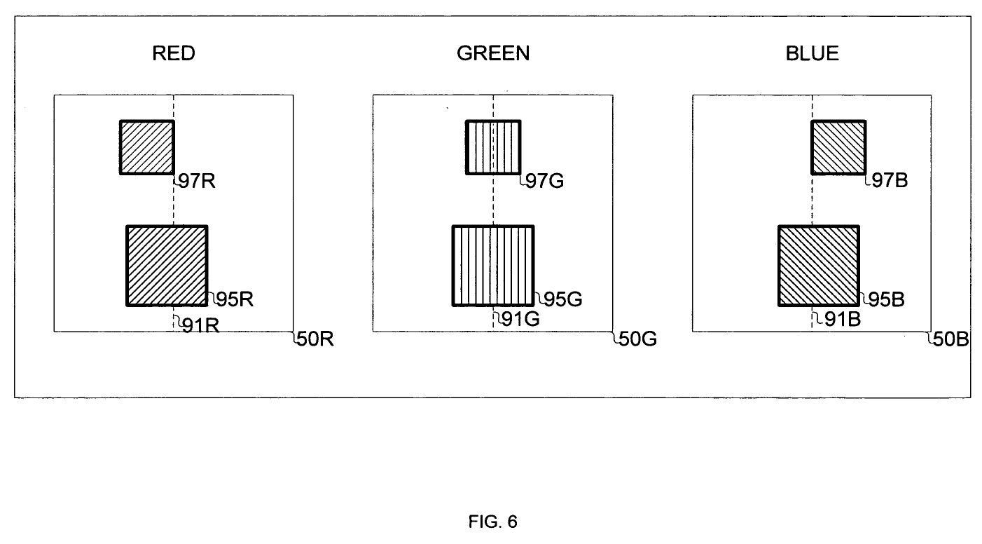

The method is described with reference to FIGS. 6-10 which depicts three lateral sensor arrays 50R, 50G, 50B representing three color planes red, green, blue, respectively. Each array 50R, 50G, 50B has a respective center line 91R, 91G, 91B used as a reference point for the following description. The center array, i.e., array 50G, serves as a reference array. Typically an image represented in array 50G is shifted by an amount ±X in arrays 50R, 50B. Depicted in each array 50R, 50G, 50B are images 97R, 97G, 97B and 95R, 95G, 95B, respectively, corresponding to two images captured by the imager. The object corresponding to images 95R, 95G, 95B is farther away from the arrays 50R, 50G, 50B when compared to the object corresponding to images 97R, 97G, 97B; thus, there is little to no shift of the images 95R, 95G, 95B from the respective center lines 91R, 91G, 91B. Because the object corresponding to images 97R, 97G, 97B is closer to the arrays 50R, 50G, 50B, there is a noticeable shift of the red and blue images 95R, 95B from the respective center lines 91R, 91B. As image 95G is the reference point there should be no shift in the green array 50G.

A first step of the de-parallax correction process is to identify the sections of the scene content that are affected by the parallax problem. This is a generally known problem with various known solutions. The presumptive first step in image processing is the recognition of the scene, separating and identifying content from the background and the foreground. Thus, with respect to the image scenes depicted in FIG. 6, conventional image processing would identify the scene content as having object images 97R, 97G, 97B and 95R, 95G, 95B.

A second step of the de-parallax correction process is to correlate the parts of the identified object images. For example, image 97R is to be aligned with image 97G and image 97B is to be aligned with image 97G. Therefore, image 97R would be correlated to image 97G and image 97B would be correlated to image 97G. Thus, the left side of image 97R would be correlated to the left side of image 97G and the right side of image 97R would be correlated to the right side of image 97G. In addition, the left side of image 97B would be correlated to left side of image 97G and the right side of image 97B would be correlated to right side of image 97G.

Similarly, image 95R is lined up with image 95G and image 95B is lined up with image 95G. Therefore, image 95R would be correlated to image 95G and image 95B would be correlated to image 95G. Thus, the left side of image 95R would be correlated to the left side of image 95G and the right side of image 95R would be correlated to the right side of image 95G. In addition, the left side of image 95B would be correlated to the left side of image 95G and the right side of image 95B would be correlated to the right side of image 95G.

There are many different known techniques for correlating color planes. For example, there are known stereoscopic correlation processes or other processes that look for similar spatial shapes and forms. The correlation step results in an understanding of the relationship between corresponding image found in each of the arrays 50R, 50G, 50B.

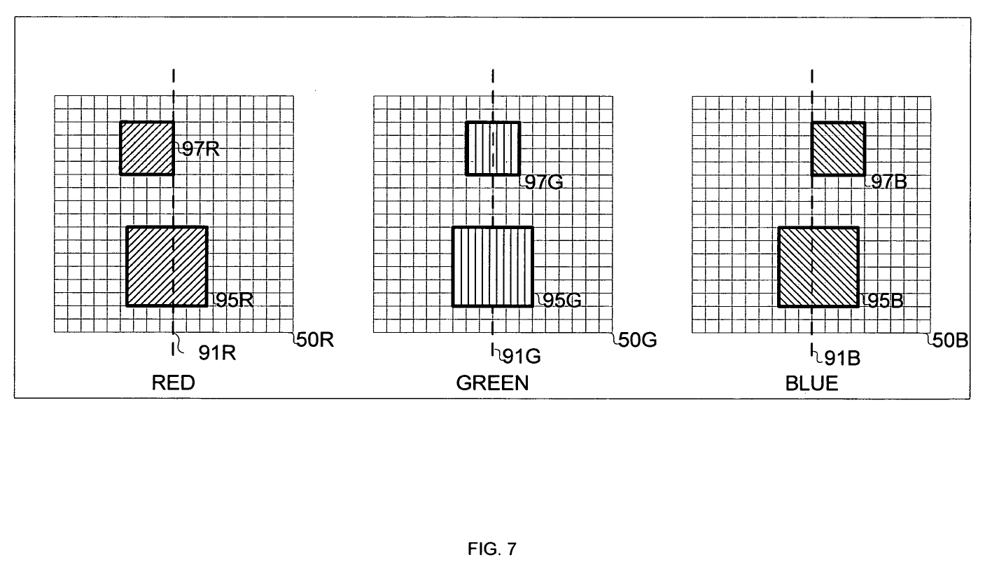

The next step of the de-parallax correction process is to shift the images in the red and blue arrays 50R, 50B such that they line up with the images in the green array 50G. Initially, the processing system of the imager are device housing the imager determines the number of pixels that need to be shifted. Presumably, image content in the red and blue color planes are shifted the absolute value of the same number of pixels. For example, red may be shifted to the right and blue may be shifted to the left, so that the image content is aligned. FIG. 7 depicts arrays 50R, 50G, 50B having images 97R, 97G, 97B and 95R, 95G, 95B. Arrays 50R, 50G, 50B are shown with 18 rows and 18 columns of pixels, but it should be appreciated that this is a mere representation of pixel arrays having any number of rows and columns.

As noted above, the amount of shifting of an image object typically depends on its distance from the imager. The closer to the imager, the greater the shifting required. Thus, images 97R, 97G, 97B are not aligned and require shifting. The farther away from the imager, generally less shifting is required. Thus, images 95R, 95G, 95B are substantially aligned and require substantially no shifting. As seen in FIG. 7, to shift image 97R to align it with image 97G, image 97R should be shifted 2 pixels to the right. To shift image 97B to align it with object 97G, image 97B should be shifted 2 pixels to the left.

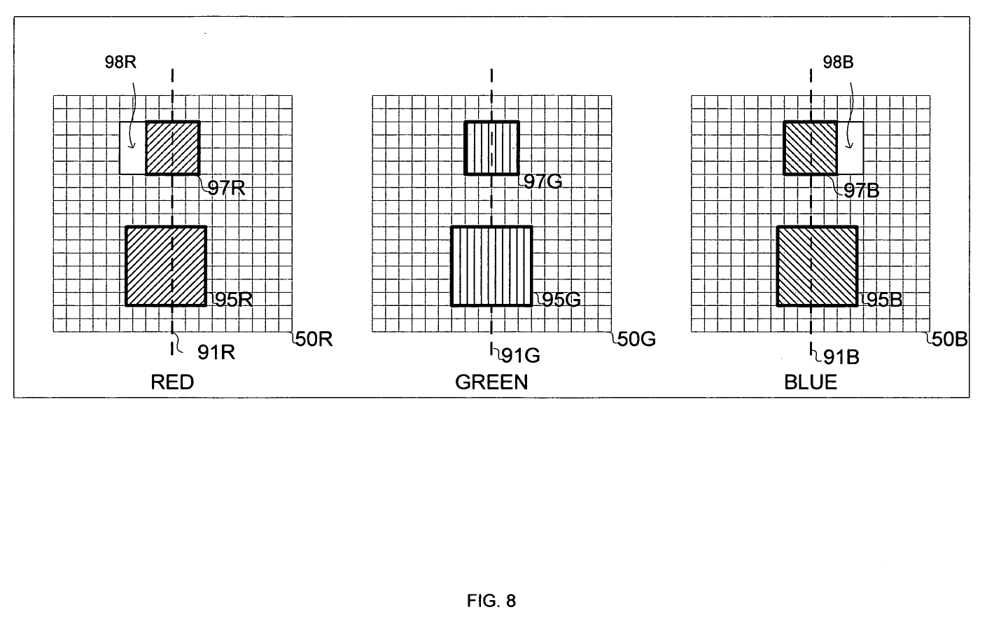

Shifting scene content in the red and blue arrays 50R, 50B results in some blank or “null” space in their columns. FIG. 8 illustrates arrays 50R, 50G, 50B having images 97R, 97G, 97B and 95R, 95G, 95B after images 97R, 97B were shifted. As seen in the red array 50R, there is a void 98R resulting from image 97R being shifted 2 pixels to the right. Void 98R is the width of the shift, i.e., 2 pixels, and the height of object 97R, i.e., 4 pixels. Similarly, in array 50B, there is a void 98B resulting from image 97B being shifted 2 pixels to the left. Void 98B is the width of the shift, i.e., 2 pixels, and the height of object 98R, i.e., 4 pixels.

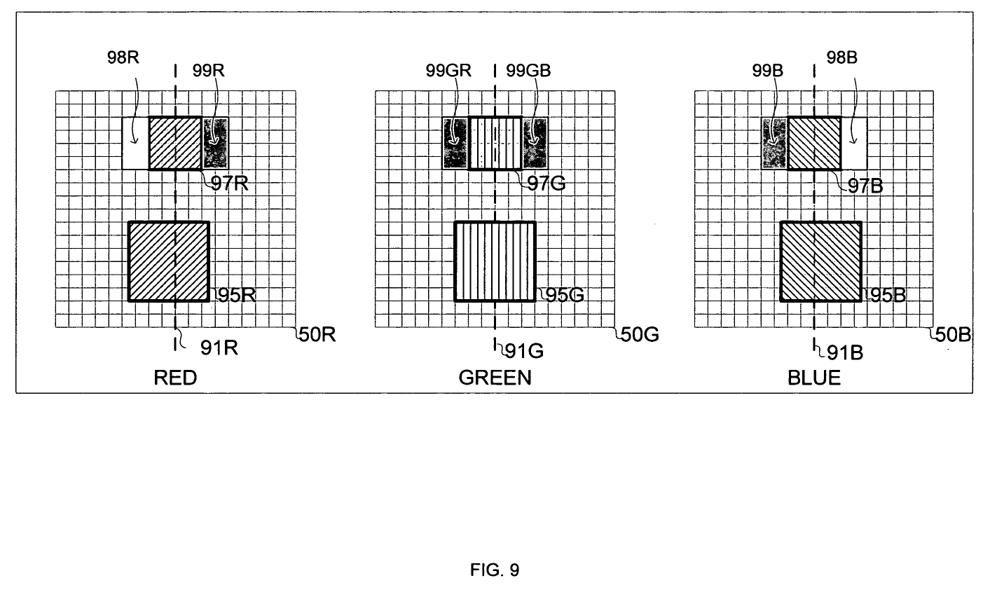

A fourth step of the de-parallax correction process is to patch all voids created by shifts. The patch occurs in two steps: patching image content and patching color content. The image information for a void can be found in the comparable section of at least one of the other arrays. The correlated image information contains pertinent information about picture structure, e.g., scene brightness, contrast, saturation, and highlights, etc. For example, as depicted in FIG. 9, image information for void 98R in array 5OR can be filled in from correlated image content 99GR of array 5OG and/or from correlated image content 99B of array 50B. Similarly, image information for void 98B in array 50B can be filled in from correlated image content 99GB of array 5OG and/or from correlated image content 99R of array 50R. Therefore, an image information patch is applied to the voids 98R, 98B from correlated image content 99B, 99R and/or correlated image content 99GR, 99GB, respectively.

Although correlated image content 99B, 99R and/or correlated image content 99GR, 99GB are used to supply missing image information, they do not have correlated color content. The correlated color content must be interpolated. One approach to determining color content is to apply a de-mosaic process to suggest what the desired color is, e.g., red based on a known color, such as e.g., green. For example, green pixels may be averaged to determine missing red information. Another approach looks at other image content in the neighborhood of the desired pixel.

Another approach is to use information from neighboring pixels. For example, a patching color content process for patching red color would interpolate color information in pixels of the array, e.g., array 50R, surrounding the void, e.g., void 98R and apply the information to the void, e.g., void 98R. This approach may require recognizing and compensating for pixels having a different parallax than that of the void 98R. An additional approach is to interpolate color values from the shifted pixels, e.g., 97R, and apply this color content information to the void, e.g., void 98R.

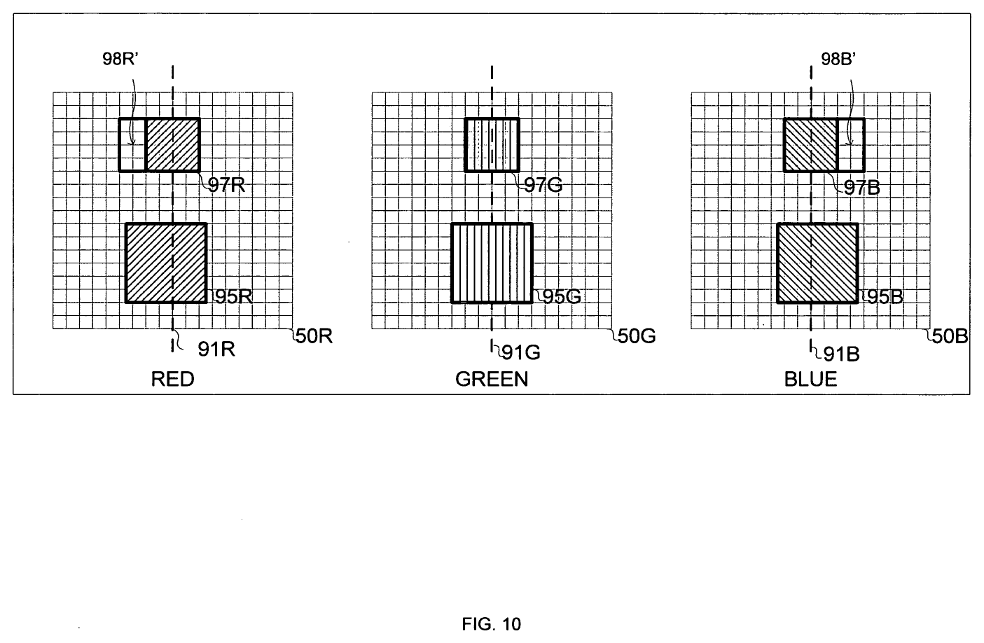

Referring to FIG. 10, at the completion of the patching process, a void, e.g., void 98R, of the array, e.g., array 50R, has been filled in with image and color content, e.g., content 98R′, and the de-parallax correction process is completed. Information can be patched from one or a plurality of other arrays. Likewise, the blue void 98B may be filled with image and color content 98B:

Generally, shifting and patching only applies to a small number of pixels. Thus, differences between actual and interpolated image and color content should be negligible. There are several approaches to applying a de-parallax correction process: no correction, some correction, and most (if not all) correction. With no correction, a resulting image from an imager array has parallax problems, which may or may not be noticeable, or which may be significant depending on the context of the scene. With some correction, a de-parallax correction process is applied to only certain objects in the scene and a resulting image from an imager array may still have parallax problems, which may or may not be noticeable, or which may be significant depending on the context of the scene. With most correction, a de-parallax correction process is applied to most if not all of the image, e.g., “locally,” and a resulting image from an imager array should have no parallax problems, which should not be noticeable, or which may be significant depending on the context of the scene.

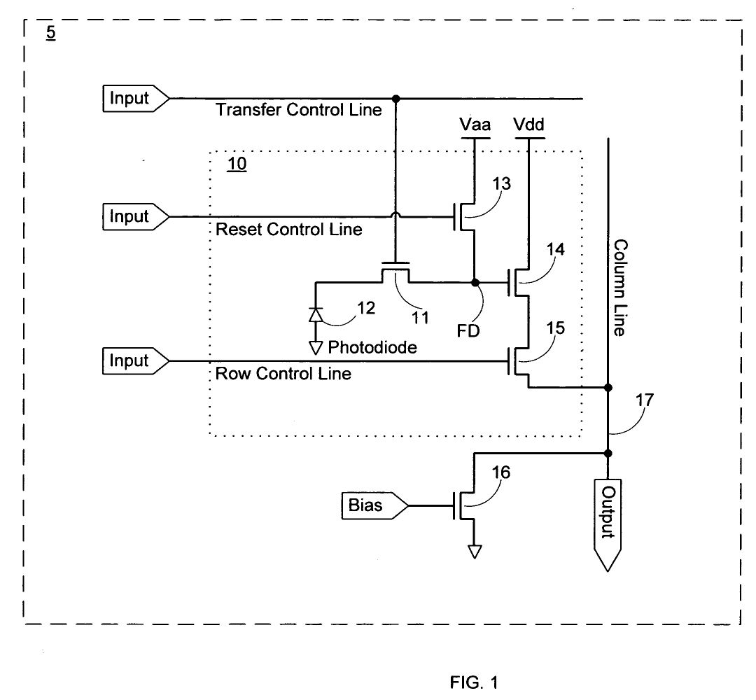

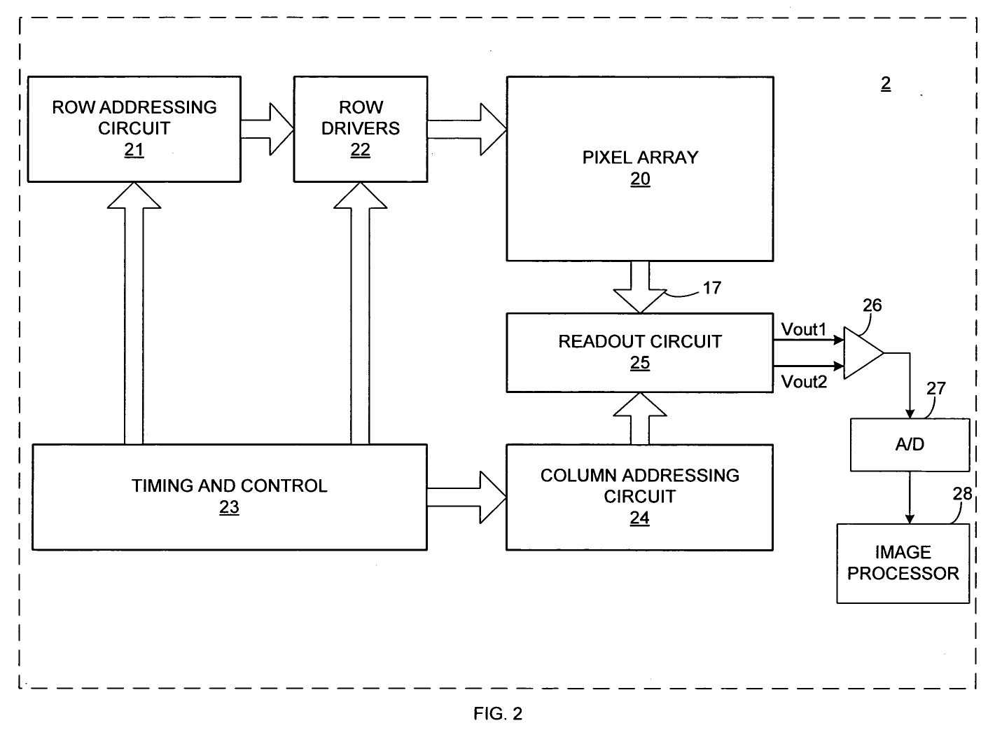

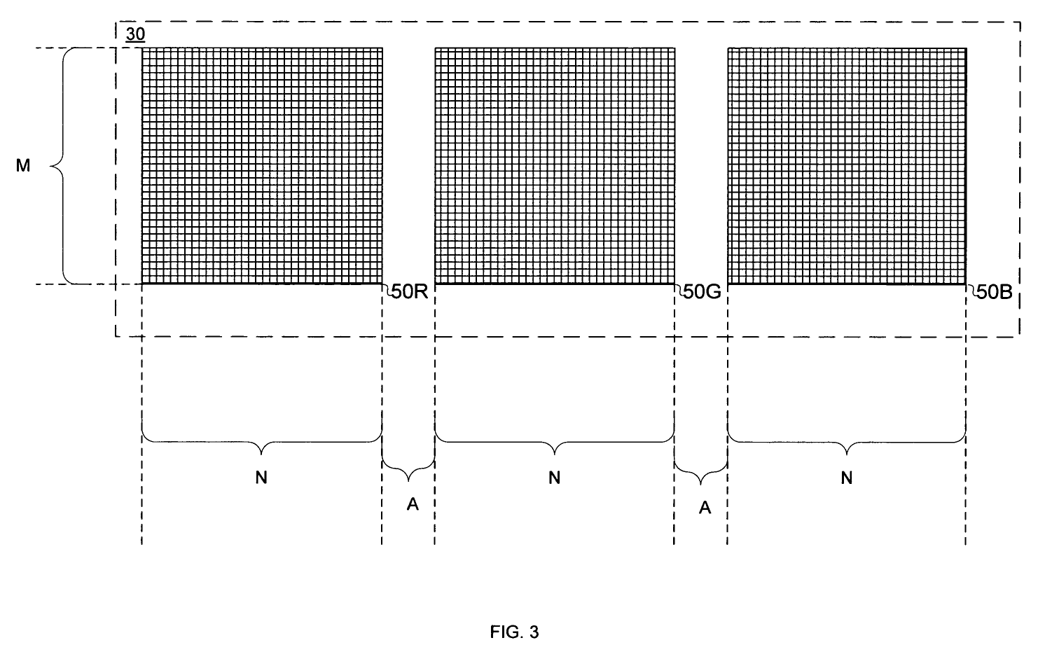

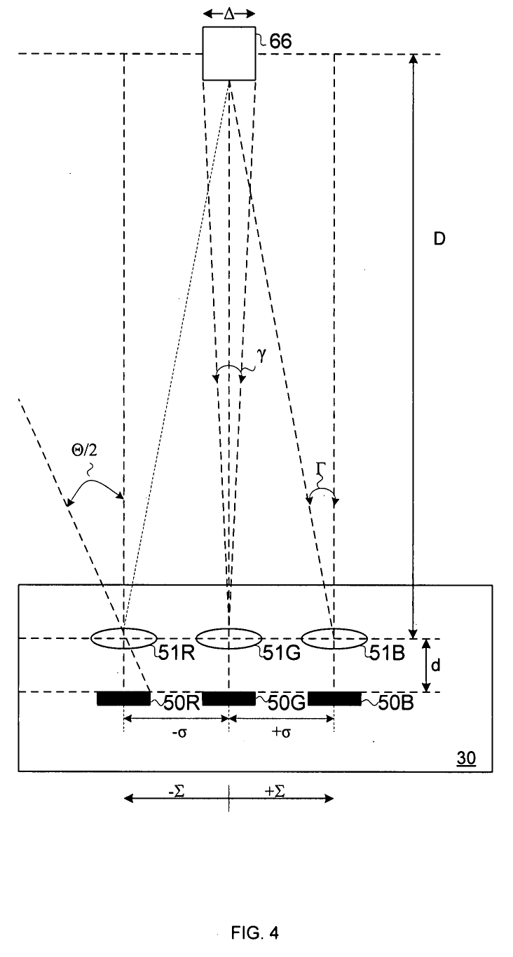

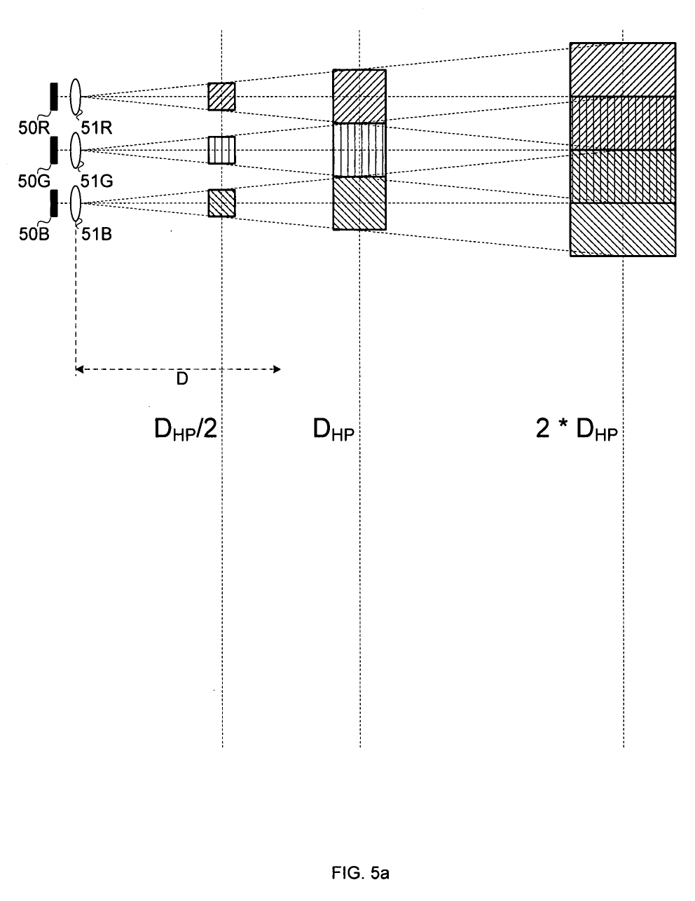

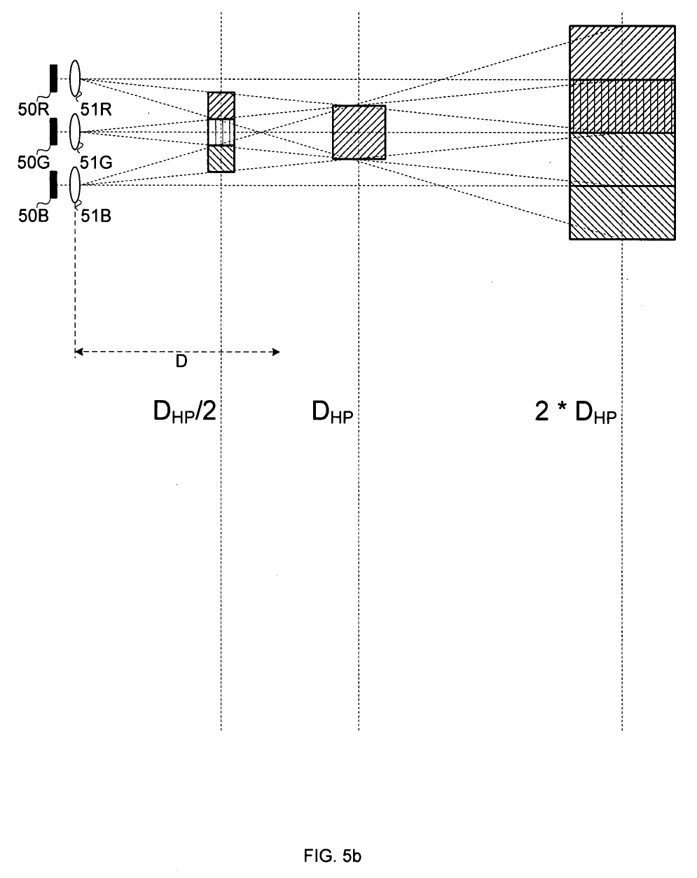

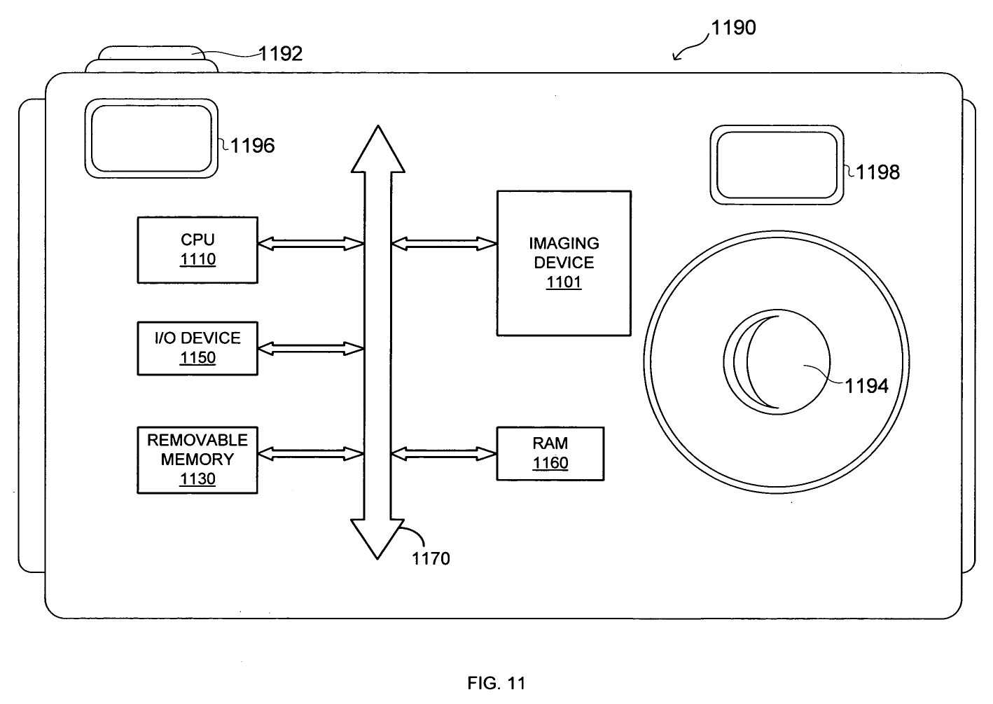

The above described image processing may be employed in an image processing circuit as part of an image device, which may be part of a processing system. FIG. 11 shows a camera system 1100, which includes an imaging device 1101 employing the processing described above with respect to FIGS. 1-10 The system 1100 is an example of a system having digital circuits that could include image sensor devices. Without being limiting, such a system could include a computer system, camera system, scanner, machine vision, vehicle navigation, video phone, surveillance system, auto focus system, star tracker system, motion detection system, image stabilization system, and other image acquisition or processing system.

System 1100, for example a camera system, generally comprises a central processing unit (CPU) 1110, such as a microprocessor, that communicates with an input/output (I/O) device 1150 over a bus 1170. Imaging device 1101 also communicates with the CPU 1110 over the bus 1170. The system 1100 also includes random access memory (RAM) 1160, and can include removable memory 1130, such as flash memory, which also communicate with the CPU 1110 over the bus 1170. The imaging device 1100 may be combined with a processor, such as a CPU, digital signal processor, or microprocessor, with or without memory storage on a single integrated circuit or on a different chip than the processor. In operation, an image is received through lens 1194 when the shutter release button 1192 is depressed. The illustrated camera system 1190 also includes a view finder 1196 and a flash 1198.

It should be appreciated that other embodiments of the invention include a method of manufacturing the system 1 100. For example, in one exemplary embodiment, a method of manufacturing a CMOS readout circuit includes the steps of fabricating, over a portion of a substrate an integrated single integrated circuit, at least an image sensor with a readout circuit as described above using known semiconductor fabrication techniques.

What is claimed as new and desired to be protected by Letters Patent of the United States is:

1. An image processing method comprising:
capturing the image using a plurality of pixel arrays;
identifying at least one object image represented in the arrays that requires de-parallax correction;
performing de-parallax correction for the identified at least one object image in at least one of the arrays; and
patching voids in the arrays where the de-parallax correction has occurred.

2. The method of claim 1, wherein the patching act comprises correcting for image content associated with the identified at least one object.

3. The method of claim 2, wherein the correcting for image content step comprises:
identifying a first void in a first one of the arrays;
identifying first correlated image content in a second one of the arrays; and
applying the first identified correlated image content to the first void.

4. The method of claim 3, wherein correlated image content comprises at least one of scene brightness, contrast, saturation, and highlights.

5. The method of claim 3, wherein the correcting for image content step further comprises:
identifying a second correlated image content in a third one of the arrays; and
applying the second correlated image content to the first void.

6. The method of claim 1, wherein the patching act comprises correcting for color content associated with the identified at least one object.

7. The method of claim 6, wherein the correcting for color content step comprises:
identifying a first color location to provide color information; and
applying interpolated color information from the first color location to the first void.

8. The method of claim 1, wherein the step of performing de-parallax correction for the identified at least one object image comprises:
correlating the identified at least one object to a corresponding object in an another of the arrays to determine a shift amount; and
shifting the identified at least one object based on the shift amount.

9. An image processing method comprising:
identifying an object image to be shifted in a first pixel array;
determining a shift amount required to align the identified object image with an another object image in a second pixel array;
shifting the identified object image based on the shift amount; and
placing image information in at least one location left void in the first pixel array after the identified object image was shifted.

10. The method of claim 9, wherein said placing image information step comprises determining image content to be placed in the void from the second pixel array.

11. The method of claim 9, wherein said placing image information step comprises determining image content to be placed in the void from the second pixel array and a third pixel array.

12. The method of claim 9, wherein said placing image information step comprises determining color content to be placed in the void from the second pixel array.

13. The method of claim 9, wherein said placing image information step comprises determining color content to be placed in the void from the second pixel array and a third pixel array.

14. An imaging device comprising:
first, second and third pixel arrays, said arrays adapted to capture an image in first, second and third colors, respectively;
an image processor coupled to said array, said image processor being programmed to:
identify at least one object image represented in the arrays that requires de-parallax correction,
perform de-parallax correction for the identified at least one object image in at least one of the arrays, and
patch voids in the arrays where the de-parallax correction has occurred.

15. The imaging device of claim 14, wherein the image processor patches voids by correcting for image content associated with the identified at least one object.

16. The imaging device of claim 14, wherein the image processor is programmed to patch voids by:
identifying a first void in a first one of the arrays;
identifying first correlated image content in a second one of the arrays; and
applying the first identified correlated image content to the first void.

17. The imaging device of claim 16, wherein the image processor further programmed to patch voids by:
identifying a second correlated image content in a third one of the arrays; and
applying the second correlated image content to the first void.

18. The imaging device of claim 14, wherein the image processor patches voids by correcting for color content associated with the identified at least one object.

19. The imaging device of claim 14, wherein the image processor is programmed to patch voids by:
identifying a first color location to provide color information; and
applying interpolated color information from the first color location to the first void.

20. The imaging device of claim 15, wherein the image processor is further programmed to patch voids by:
correlating the identified at least one object to a corresponding object in an another of the arrays to determine a shift amount; and
shifting the identified at least one object based on the shift amount.

21. The imaging device of claim 14, wherein the image processor patches voids by correcting for color content and image content associated with the identified at least one object.

22. An imaging device comprising:
first, second and third pixel arrays, said arrays adapted to capture an image in first, second and third colors, respectively; and
an image processor coupled to said array, said image processor being programmed to:
identify an object image to be shifted in a first pixel array,
determine a shift amount required to align the identified object image with an another object image in a second pixel array,
shift the identified object image based on the shift amount, and
place image information in at least one location left void in the first pixel array after the identified object image was shifted.

23. The imaging device of claim 22, wherein said image processor is adapted to place image information by determining image content to be placed in the void from the second pixel array.

24. The imaging device of claim 22, wherein said image processor is adapted to place image information by determining image content to be placed in the void from the second pixel array and the third pixel array.

25. The imaging device of claim 22, wherein said image processor is adapted to place image information by determining color content to be placed in the void from the second pixel array.

26. The imaging device of claim 22, wherein said image processor is adapted to place image information by determining color content to be placed in the void from the second pixel array and the third pixel array.
